(19) United States
(12) Patent Application Publication
(10) Pub. No.: US 2026/0063881 A1
(43) Pub. Date: Mar. 5, 2026

(54) OPTICAL INSPECTION APPARATUS AND OPERATION METHOD OF THE SAME

(71) Applicant: OmniMeasure Technology Inc., Hsinchu (TW)

(72) Inventors: Chao-Chang CHEN, Hsinchu (TW); Hung-Ming TAI, Hsinchu (TW); Hsiang-Chun WEI, Hsinchu (TW); Dian-Yu LI, Hsinchu (TW)

(21) Appl. No.: 19/241,355

(22) Filed: Jun. 17, 2025

Related U.S. Application Data
(60) Provisional application No. 63/688,845, filed on Aug. 29, 2024.

(51) Int. Cl. G02B 21/00; G02B 21/06; G02B 21/22; G02B 21/24; G02B 21/36

(52) U.S. Cl. CPC G02B 21/0016; G02B 21/06; G02B 21/22; G02B 21/245; G02B 21/367

(57) ABSTRACT

An optical inspection apparatus includes a projection optical system, a digital microscope system, and a calculating unit electrically connected to the projection optical system and the digital microscope system. The projection optical system is configured to obtain an inclined projection image of multiple through hole structures in a substrate. The digital microscope system is configured to obtain a 2D interference image. The calculating unit is electrically connected to the projection optical system and the digital microscope system. The calculating unit is configured to analyze the 2D interference image to obtain a stereoscope image data and to analyze the inclined projection image to obtain multiple parameters of the through hole structures. The optical inspection apparatus can be used to get a feedback in real-time. Multiple through hole structures can be inspected at the same time such that the time required to scan the substrate is reduced.

### CROSS-REFERENCE TO RELATED APPLICATION

This application claims priority to U.S. Provisional Application Ser. No. 63/688,845, filed Aug. 29, 2024, which is herein incorporated by reference in its entirety.

### BACKGROUND

### Field of Invention

The present invention relates to an optical inspection apparatus. More particularly, the present invention relates to a contactless and nondestructive inspection apparatus.

### Description of Related Art

In the semiconductor inspection field, common inspection methods are, for example, laser confocal microscopy, color confocal microscopy, or white light scan technology. However, such methods cannot inspect multiple through holes at the same time. In addition, those methods are time-consuming. For example, a conventional SEM scan method takes about 30 minutes for preceding procedures. Furthermore, a taper angle of the corners of the through holes cannot be analyzed by current inspection methods. However, the taper angles of the corners of the through holes are crucial to the metal plating process due to much smaller critical dimension nowadays.

Accordingly, how to reduce the processing time (e.g., reduced to about a few seconds) and how to provide an optical inspection apparatus and operation method for through holes is still one of the goals that urgently need to be developed.

### SUMMARY

One aspect of the present disclosure is an optical inspection apparatus.

In one embodiment, an optical inspection apparatus includes a projection optical system, a digital microscope system, and a calculating unit electrically connected to the projection optical system and the digital microscope system. The projection optical system is configured to obtain an inclined projection image of multiple through hole structures in a substrate. The digital microscope system is configured to obtain a 2D interference image. The calculating unit is electrically connected to the projection optical system and the digital microscope system. The calculating unit is configured to analyze the 2D interference image to obtain a stereoscope image data and to analyze the inclined projection image to obtain multiple parameters of the through hole structures.

In one embodiment, the projection optical system further includes a light source configured to illuminate a back side of the substrate, a projection lens located at a front side of the substrate, and an image sensor configured to record an imaging from the projection lens. The projection lens is configured to obtain the inclined projection image of the through hole structures.

In one embodiment, the projection lens of the projection optical system is a telocentric lens.

In one embodiment, the calculating unit is configured to perform extend depth of focus algorithm or all in focus algorithm to obtain the parameters of the through hole structures.

In one embodiment, the through hole structures are etched through holes, and the parameters include top critical dimension, middle critical dimension, bottom critical dimension, taper angle, pitch, diameter, roughness, height and central line.

In one embodiment, the through hole structures are laser modified regions, and the parameters include depth, angle, pitch, density, line width, and inner crack.

In one embodiment, the digital microscope system further includes a laser light source configured to emit an incident light and an image sensor configured to record the 2D interference image formed by the incident light passed through the through hole structures.

In one embodiment, the optical inspection apparatus further includes a carrier. The substrate is disposed on the carrier, and the distance between the carrier and the image sensor is adjustable.

In one embodiment, the calculating unit is configured to perform back-propagation reconstruction algorithm on the 2D interference image to obtain the 3D image stack of the through hole structures.

In one embodiment, the calculating unit is configured to perform twin image elimination algorithm to the 3D image stack.

In one embodiment, the calculating unit is configured to perform super-resolution algorithm to the 3D image stack.

In one embodiment, the through hole structures are etched through holes, and the stereoscope image data includes top critical dimension, middle critical dimension, bottom critical dimension, taper angle, top roundness, bottom roundness, pitch, diameter, height, axial line, surface roughness, cross-sectional views, and map scan.

In one embodiment, the through hole structures are laser modified regions, and the stereoscope image data includes laser modification precision and map scan.

Another aspect of the present disclosure is an operation method of an optical inspection apparatus.

In one embodiment, the operation method of an optical inspection apparatus includes forming multiple etched through holes in a substrate, obtaining a first inclined projection image of the etched through holes by a projection optical system, obtaining a first 2D interference image of the etched through holes by a digital microscope system, and analyzing the first inclined projection image to obtain multiple parameters and analyzing the first 2D interference image to obtain a stereoscope image data by a calculating unit.

In one embodiment, the operation method of an optical inspection apparatus further includes calculating a minimum pitch based on a predetermined diameter of the etched through holes and a thickness of the substrate by the calculating unit before forming the etched through holes in the substrate.

In one embodiment, obtaining the first inclined projection image of the etched through holes by the projection optical system further includes illuminating a back side of the substrate by a light source module, obtaining the first inclined projection image of the etched through holes through a projection lens; and recording an imaging of the projection lens by an image sensor.

In one embodiment, obtaining the first 2D interference image of the etched through holes by the digital microscope system further includes emitting an incident light towards the substrate by a laser light source; and recording the image formed by the incident light passed through the etched through holes by an image sensor.

In one embodiment, the operation method of an optical inspection apparatus further includes performing a laser modification to the substrate to form multiple laser modified regions before forming the etched through holes in the substrate.

In one embodiment, the operation method of an optical inspection apparatus further includes calculating a minimum pitch based on a predetermined line width of the laser modified regions and a thickness of the substrate by the calculating unit before performing the laser modification to the substrate to form the laser modified regions.

In one embodiment, the operation method of an optical inspection apparatus further includes obtaining a second inclined projection image of the laser modified regions by the projection optical system; and obtaining a second 2D interference image of the laser modified regions by the digital microscope system.

In the aforementioned embodiments, the optical inspection apparatus is a contactless and nondestructive inspection method, such that a feedback can be provided in real-time. The shape and profile of the through hole structures can be obtained from the inclined projection image from a projection optical system and a 2D interference image from a digital microscope system. In addition, multiple through hole structures can be inspected at the same time such that the time required to scan the substrate is reduced. The taper angles of four corners of the through hole structures can be inspected such that the metal plating process can be applied to form through hole vias (i.e. metal conductors) that have much smaller critical dimensions.

### BRIEF DESCRIPTION OF THE DRAWINGS

The invention can be more fully understood by reading the following detailed description of the embodiment, with reference made to the accompanying drawings as follows:

FIG. 1A is a schematic diagram of an optical inspection apparatus according to one embodiment of the present disclosure.

FIG. 1B is a projection optical system according to one embodiment of the present disclosure.

FIG. 1C is a digital microscope system according to one embodiment of the present disclosure.

FIG. 2 is a schematic diagram of images obtained by the projection optical system.

FIG. 3A to FIG. 3D are images of a laser modified substrate obtained by the projection optical system.

FIG. 4 is an image of the etched through holes obtained by the projection optical system.

FIG. 5 is an image of the etched through holes obtained by the projection optical system.

FIG. 6 is a 2D profile analyzed from an image obtained by the projection optical system.

FIG. 7 is a schematic diagram of parameters analyzed form an image obtained by the projection optical system.

FIG. 8 is a roughness profile analyzed form an image obtained by the projection optical system.

FIG. 9 is a schematic diagram of the generating of the 2D interference image according to one embodiment of the present disclosure.

FIG. 10 is a 2D interference image obtained by the digital microscope system in FIG. 9.

FIG. 11 is a 3D image stack obtained by the digital microscope system in FIG. 9.

FIG. 12 is a stereoscope image reconstructed from the 3D image stack in FIG. 11.

FIG. 13 is an image of a laser modified substrate obtained by the digital microscope system according to one embodiment of the present disclosure.

FIG. 14A to FIG. 14E are images of the etched through holes obtained by the digital microscope system according to one embodiment of the present disclosure.

FIG. 15 is a schematic diagram of reconstruct a 3D point cloud data of through holes structures.

FIG. 16A is a schematic diagram of an inspection angle according to one embodiment of the present disclosure.

FIG. 16B is a schematic diagram of an inspected image obtained with the inspection angle shown in FIG. 16A.

FIG. 17A and FIG. 17B are schematic diagram of inspected images with overlapped through hole structures.

FIG. 18 is a schematic diagram of a rotation angle according to one embodiment of the present disclosure.

FIG. 19 is a minimum pitch diagram based on a minimum pitch equation.

FIG. 20 is a schematic diagram of an inspected image of a laser modified substrate according to one embodiment of the present disclosure.

FIG. 21 is a flow chart of an operation method of an optical inspection apparatus.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

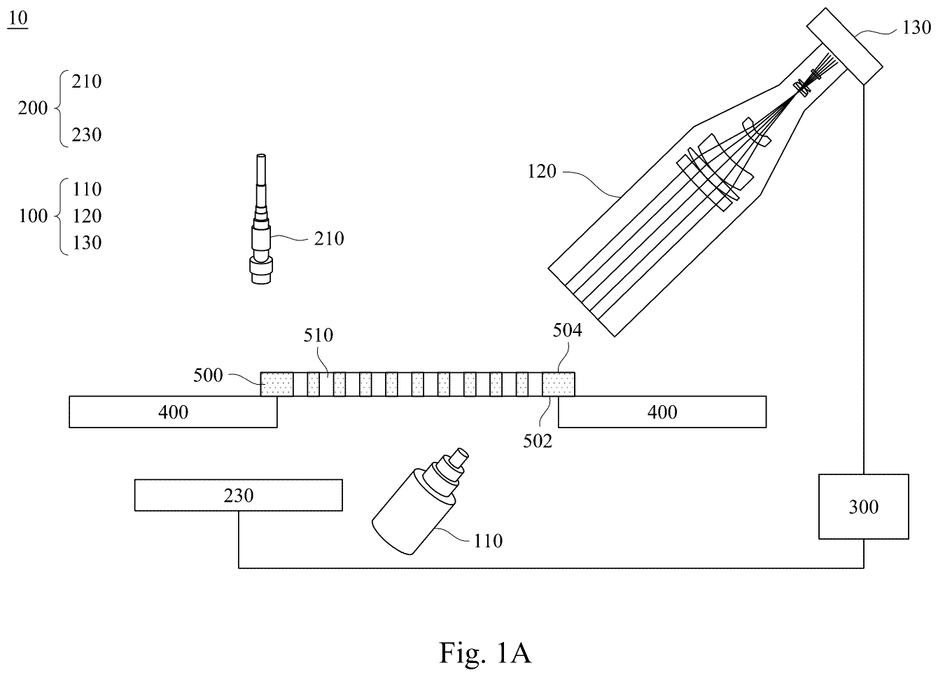

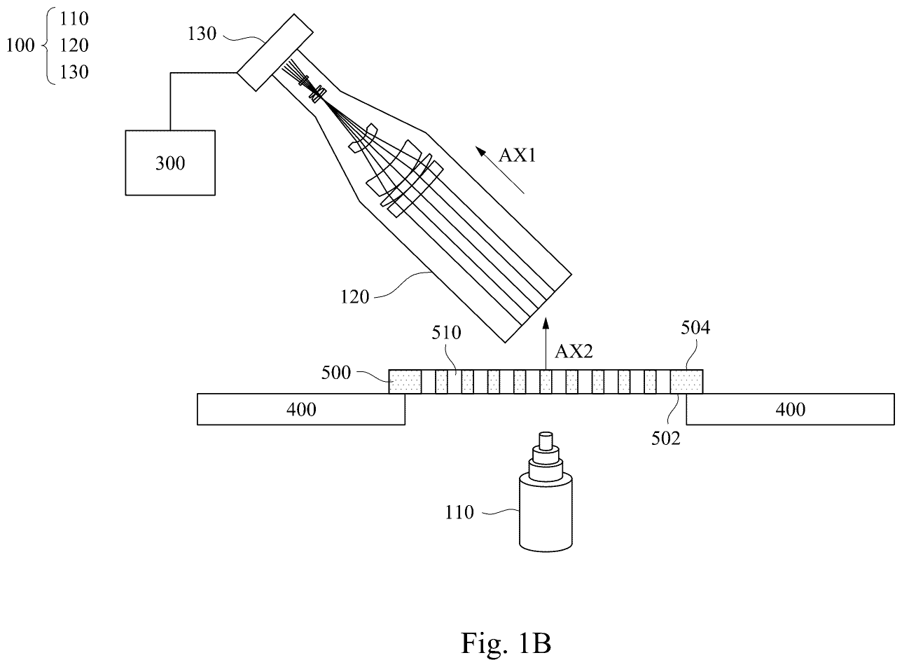

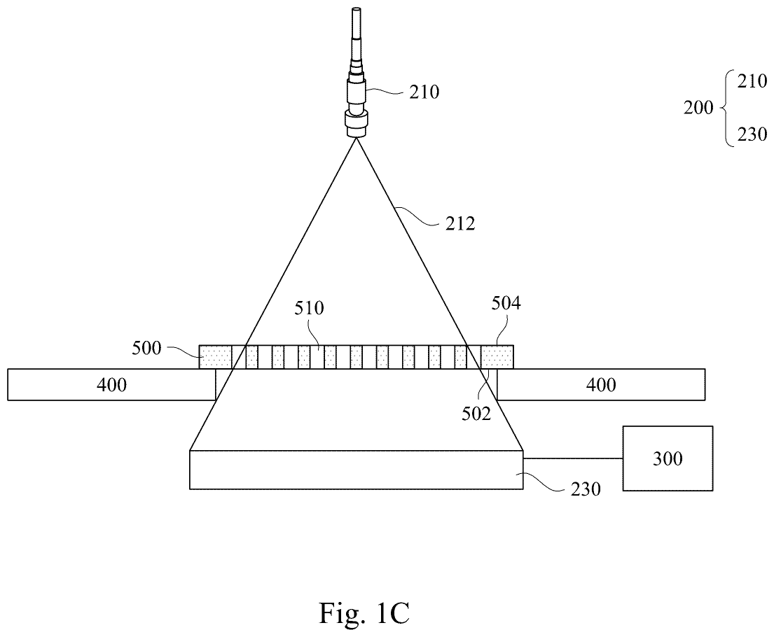

FIG. 1A is a schematic diagram of an optical inspection apparatus 10 according to one embodiment of the present disclosure. The optical inspection apparatus 10 includes a projection optical system 100, a digital microscope system 200, a calculating unit 300 and a carrier 400. A substrate 500 to be inspected is disposed on the carrier 400. The substrate 500 is transparent or semi-transparent, such as a glass substrate, an acrylic substrate, or a silicon substrate. In the present embodiment, the projection optical system 100 is a non-orthogonal projection optical system, but the present disclosure is not limited thereto.

The projection optical system 100 and the digital microscope system 200 are configured to inspect multiple through hole structures 510 in the substrate 500. Before an etching process and after a laser modification process, the through hole structures 510 represent laser modified regions. After the etching process, the through hole structures 510 represent the etched through holes formed at the positions of the laser modified regions. The etched through holes are subsequently filled with metal in a metal plating process to form the through hole vias (i.e. metal conductors).

The projection optical system 100 is configured to obtain an inclined projection image of the through hole structures 510 of the substrate 500. The digital microscope system 200 is configured to obtain a 2D interference image of the through hole structures 510 of the substrate 500. The calculating unit 300 is electrically connected to the projection optical system 100 and the digital microscope system 200. The calculating unit 300 is configured to analyze the inclined projection image from the projection optical system 100 to obtain multiple parameters of the substrate 500 and to analyze the 2D interference image from the digital microscope system 200 to obtain a stereoscope image data of the substrate 500.

FIG. 1B is a projection optical system 100 according to one embodiment of the present disclosure. The projection optical system 100 includes a light source 110, a projection lens 120 and an image sensor 130. The light source 110 is configured to illuminate a back side 502 of the substrate 500. The projection lens 120 is located at a front side 504 of the substrate 500. The projection lens 120 is configured to obtain the inclined projection image of the through hole structures 510. The image sensor 130 is configured to record an imaging from the projection lens 120.

The projection lens 120 of the projection optical system 100 is a telecentric lens. In the present embodiment, a first optical axis AX1 of projection lens 120 and a second optical axis AX2 of a planar diffused light emitted from the light source 110 have an angle therebetween. For example, the angle is in a range from 40 degrees to 50 degrees. In the present embodiments, the angle is 45 degrees. In some other embodiments, the optical axis of the projection lens 120 and the optical axis of the planar diffused light emitted from the light source 110 are parallel with each other (such as the embodiment in FIG. 1A). That is, the illumination method can be dark field illumination or bright field illumination. In addition, the shape of the light beam emitted from the laser light source 210 is not limited.

FIG. 1C is a digital microscope system 200 according to one embodiment of the present disclosure. The digital microscope system 200 includes a laser light source 210 and an image sensor 230. The laser light source 210 is a point light source and is configured to emit an incident light 212. The image sensor 230 is configured to record the 2D interference image formed by the incident light 212 passed through the through hole structures 510 of the substrate 500. In some embodiments, the distance between the carrier 400 and the image sensor 230 is adjustable so as to improve the resolution. The digital microscope system 200 is a lens-free system such as a digital lensless holographic microscopy or digital axis holographic microscopy, but the present disclosure is not limited thereto.

In some embodiments, the projection optical system 100 and the digital microscope system can be utilized separately. The optical inspection apparatus 10 is a contactless and nondestructive inspection method, such that a feedback can be provided in real-time.

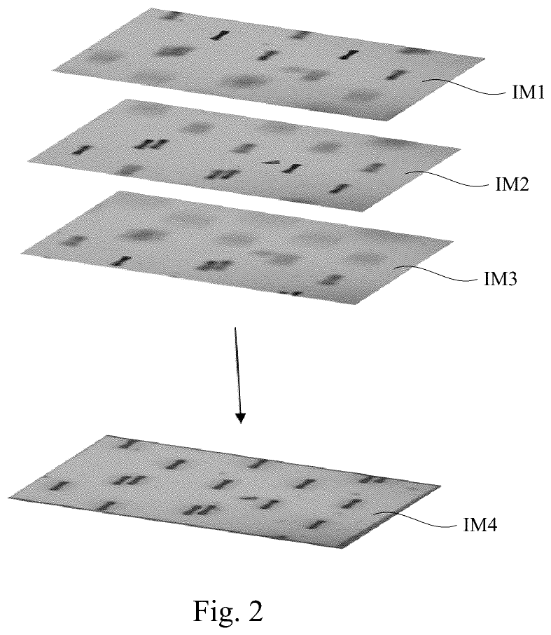

FIG. 2 is a schematic diagram of images obtained by the projection optical system 100. Reference is made to FIG. 1B and FIG. 2. The projection optical system 100 scans the substrate 500 to obtain multiple inclined projection images IM1, IM2, and IM3. In the present disclosure, the calculating unit 300 is configured to perform extend depth of focus algorithm to obtain the processed image IM4. The extend depth of focus is used to enhance the depth of the inclined projection images. As such, the profile of the through hole structures 510 in the processed image IM4 is more precise than the profile of the through hole structures 510 in the inclined projection images IM1, IM2, and IM3.

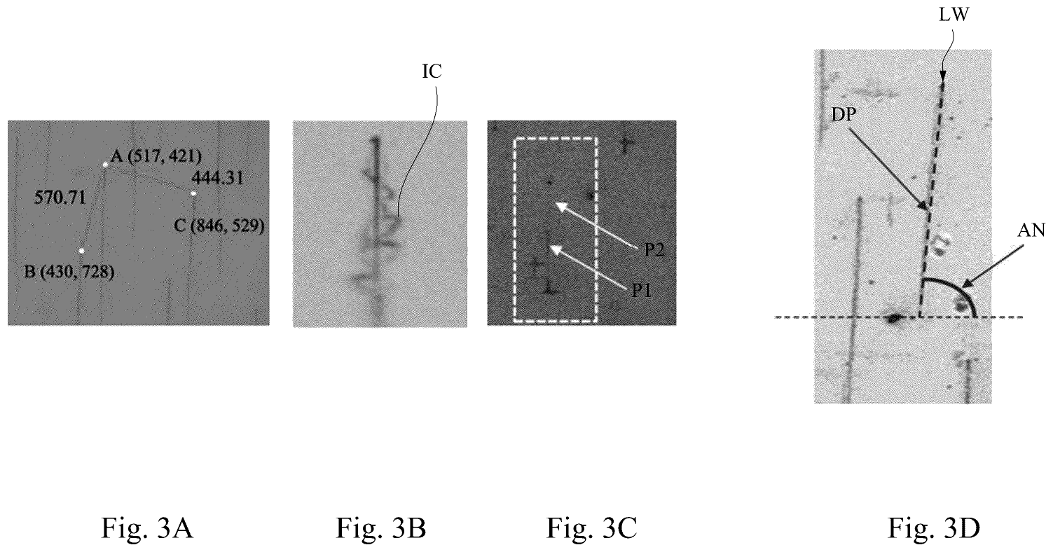

FIG. 3A to FIG. 3D are images of a laser modified substrate obtained by the projection optical system 100. Reference is made to FIG. 1B and FIG. 3A to FIG. 3D. Those images of the laser modified regions 510 are processed by, for example, the extend depth of focus algorithm to increase the resolution. Then, those images are analyzed to obtain multiples parameters of the laser modified regions 510 by the calculating unit 300.

For example, the parameters of the laser modified regions 510 include depth, angle, pitch, density, line width, and inner crack, but the present disclosure is not limited thereto. Those parameters will be described in detail in FIG. 3A to FIG. 3D.

FIG. 3A is an image demonstrating coordinates of the laser modified regions 510. As such, the pitch between the laser modified regions 510 can be calculated. FIG. 3B is an image demonstrating the inner crack IC occurred around the laser modified regions 510. FIG. 3C is an image demonstrating a dense part P1 and a diluted part P2 of the laser modified region 510. FIG. 3D is an image demonstrating a depth DP, a line width LW, and an angle AN of a laser modified region 510. The angle AN means the angle of the lengthwise direction of the laser modified region 510 and the lateral direction of the laser modified substrate 500.

Accordingly to the parameters inspected by the projection optical system 100, the quality of laser modification can be determined and reported so as to improve the laser modification process.

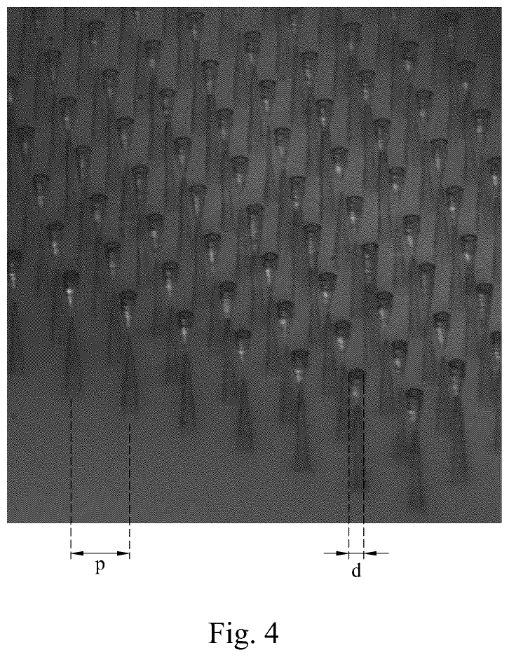

FIG. 4 is an image of the etched through holes obtained by the projection optical system 100. Reference is made to FIG. 1B and FIG. 4. In the present embodiment, the image is an inclined projection image been processed by using an all in focus algorithm. In some other embodiments, other algorithms that can improve or extend of the depth of field of the telecentric lens can be cooperated in the projection optical system 100.

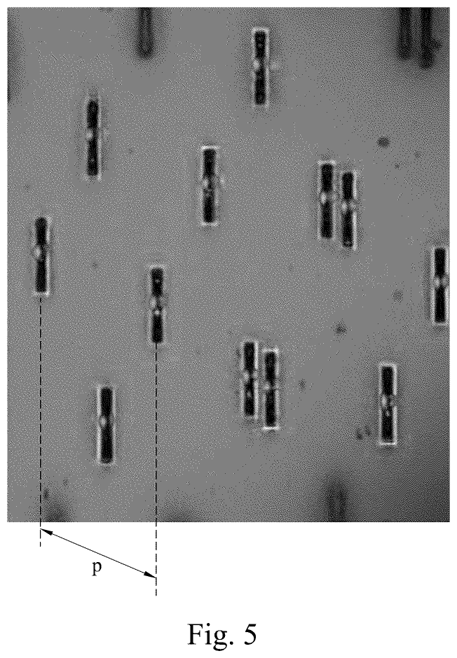

FIG. 5 is an image of the etched through holes obtained by the projection optical system 100. Reference is made to FIG. 1B and FIG. 5. The image of the etched through holes 510 are processed and are analyzed to obtain multiples parameters of the etched through holes 510 by the calculating unit 300. The parameters analyzed from the inclined projection images are calibrated to obtain the parameters corresponding to an orthogonal image of the etched through holes 510. As such, information of a left sidewall and a right sidewall of an etched through hole can be analyzed.

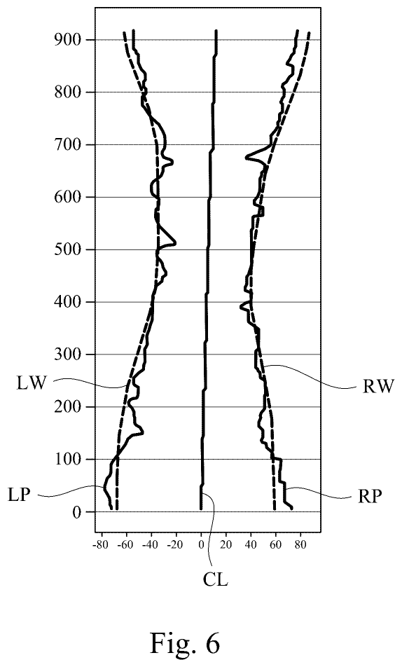

For example, the parameters of the etched through holes 510 include top critical dimension, middle critical dimension, bottom critical dimension, pitch, diameter, shape, roughness, height and central line, but the present disclosure is not limited thereto. Those parameters will be described in detail in FIG. 6 to FIG. 8.

FIG. 6 is a 2D profile analyzed from an image obtained by the projection optical system 100. Reference is made to FIG. 1B and FIG. 6. The 2D profile shown in FIG. 6 of an etched through hole 510 shows the left profile LP, the right profile RP, the left waviness LW, the right waviness RW, and the central line CL.

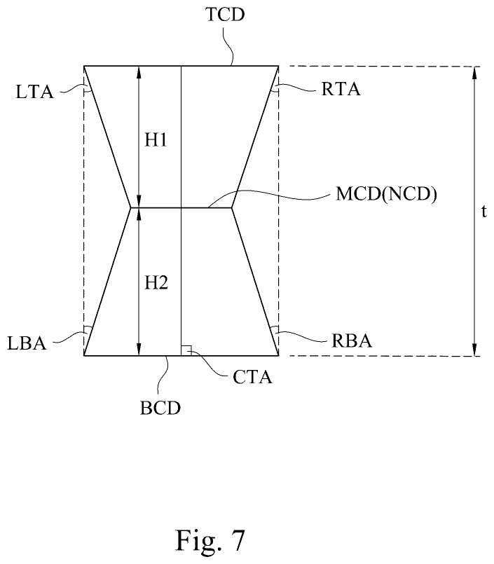

FIG. 7 is a schematic diagram of parameters analyzed form an image obtained by the projection optical system 100. Reference is made to FIG. 1B and FIG. 7. The schematic diagram of an etched through hole has an hourglass shape in a cross-sectional view. The schematic diagram of an etched through hole 510 shows the top critical dimension TCD, the middle critical dimension MCD, the bottom critical dimension BCD, the shape, the heights H1, H2, and the central tilt angle CTA. The middle critical dimension MCD is the half-height dimension. A narrowest critical dimension (NCD) is the dimension measured at the narrowest region of the etched through hole. In the present embodiment, the narrowest critical dimension NCD and the middle critical dimension MCD are at the same position. In alternative embodiments, the position of the narrowest critical dimension NCD may be higher or lower than the position of the middle critical dimension MCD. The diameter of the etched through hole 510 is substantially equals to the top critical dimension TCD, or an average of the top critical dimension TCD, the middle critical dimension MCD, the bottom critical dimension BCD, but the present disclosure is not limited thereto.

Parameters of the shape includes taper angles of four corners, such as left top taper angle LTA, right top taper angle RTA, left bottom taper angle LBA, and right bottom taper angle RBA. The heights include a first height H1 and a second height H2. The first height H1 represents the distance from the top to the narrowest region of the etched through hole 510. The second height H2 represents the distance from the narrowest region to the bottom of the etched through hole 510. A height ratio between the first height H1 and the second height H2 can be determined. A thickness of the substrate 500 is substantially the sum of the first height H1 and the second height H2.

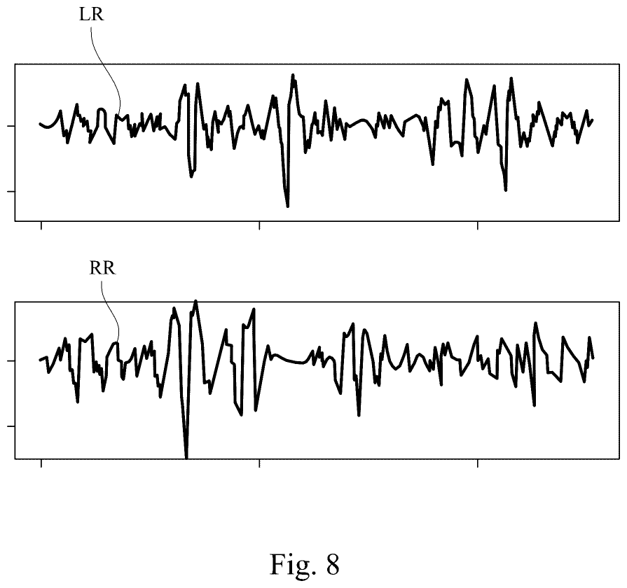

FIG. 8 is a roughness profile analyzed form an image obtained by the projection optical system 100. Reference is made to FIG. 1B and FIG. 8. The roughness profile shows the left roughness LR and the right roughness RR of the etched through hole 510.

By scanning the substrate 500 with the projection optical system 100 and by processing and analyzing the inclined projection images, the profile of the etched through holes 510 from top to bottom can be inspected. Specifically, in a conventional method, only top part or a bottom part of an etched through hole can be inspected clearly in an orthogonal image. Therefore, any broken part or blockage in the through hole structures 510 which cannot been seen in an orthogonal image can be seen clearly in the inclined projection images by using the projection optical system. In addition, multiple through hole structures can be inspected at the same time such that the time required to scan the substrate is reduced. The taper angles of four corners of the through hole structures can be inspected such that the metal plating process can be applied to form through hole vias (i.e. metal conductors) that have much smaller critical dimensions (e.g., critical dimension smaller than 5 μm and taper angle smaller than 8 degrees).

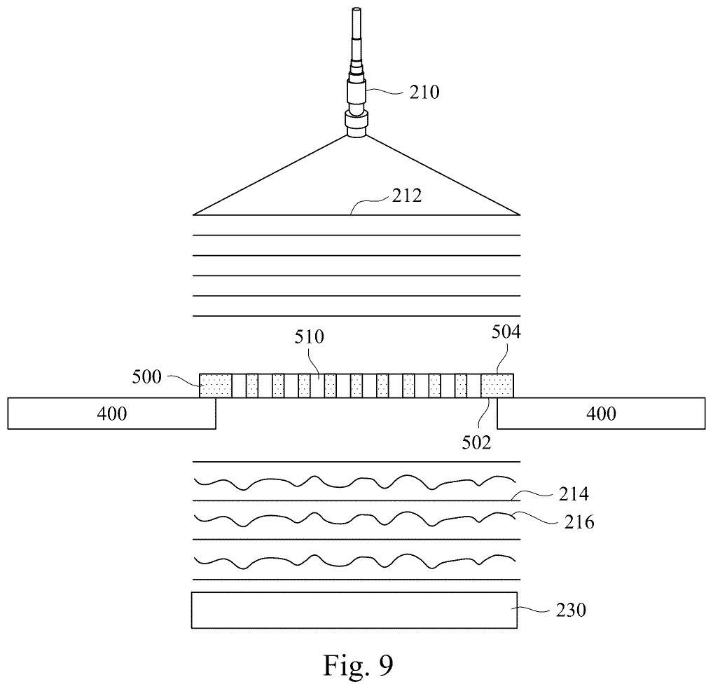

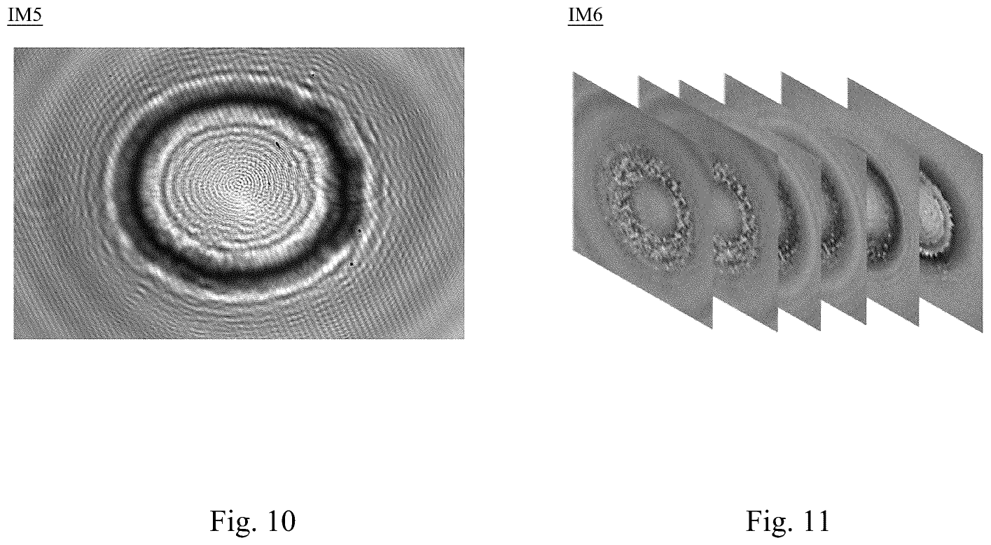

FIG. 9 is a schematic diagram of the generating of the 2D interference image according to one embodiment of the present disclosure. FIG. 10 is a 2D interference image IM5 obtained by the digital microscope system 200 in FIG. 9. Reference is made to FIG. 1C, FIG. 9, and FIG. 10. The incident light 212 has a plane wave traveling towards the front side 504 of the substrate 500. A portion of the incident light 212 that is not disturbed by the through hole structures 510 becomes the undisturbed light 214. Another portion of the incident light 212 that is disturbed by the through hole structures 510 becomes the disturbed light 216. The undisturbed light 214 and the disturbed light 216 interferes with each other to form a 2D interference image IM5.

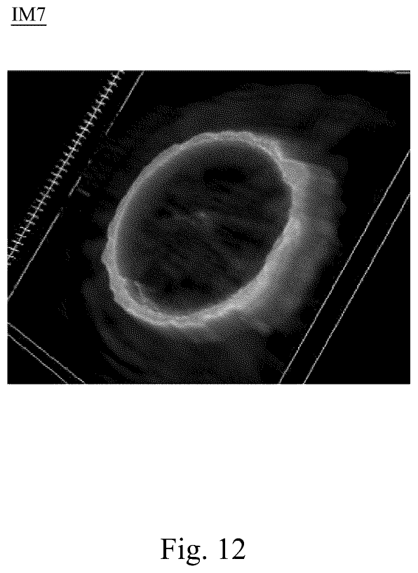

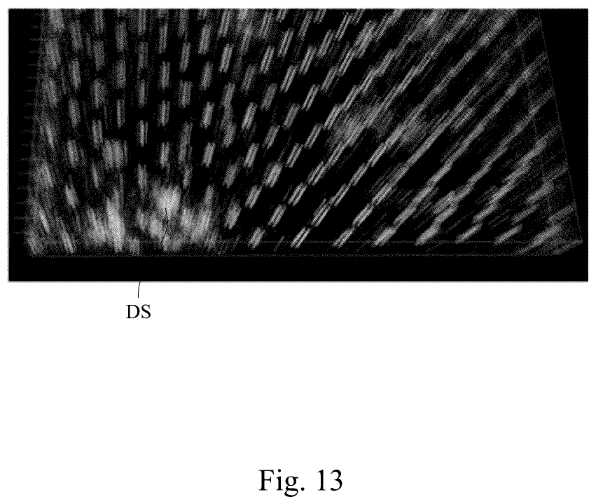

FIG. 11 is a 3D image stack IM6 obtained by the digital microscope system 200 in FIG. 9. Reference is made to FIG. 1C, FIG. 10 and FIG. 11. The calculating unit 300 is configured to perform back-propagation reconstruction algorithm on the 2D interference image IM5 to obtain the 3D image stack IM6 of the etched through hole 510. The back-propagation reconstruction algorithm is used to calculate gradient information from the 2D interference image IM5, such that the 3D structural detail can be reconstructed. FIG. 12 is a 3D image IM7 reconstructed from the 3D image stack IM6 in FIG. 11. In some other embodiments, the extend depth of focus algorithm mentioned above or other algorithm can also be applied in the 2D interference image.

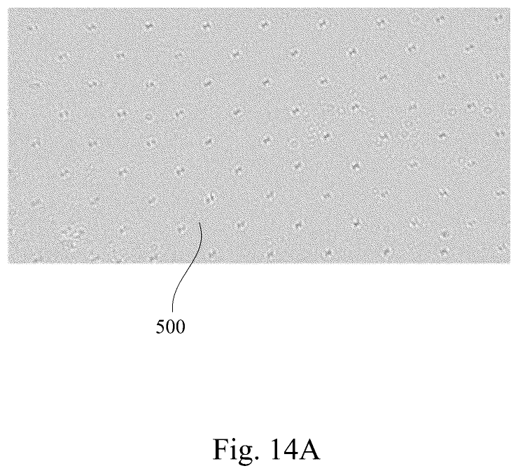

FIG. 13 is an image of a laser modified substrate obtained by the digital microscope system 200 according to one embodiment of the present disclosure. Reference is made to FIG. 1C and FIG. 13. The 3D image stack of the laser modified substrate 500 are processed by using a twin image elimination algorithm and/or a super-resolution algorithm to improve the resolution and are analyzed to obtain stereoscope image data of the laser modified regions 510 in the substrate 500. For example, the stereoscope image data of the laser modified regions 510 include laser modification precision and map scan. As shown in FIG. 13, the miss shoot or double shoot DS of laser modification operation can be revealed through the 3D image. Therefore, the laser modification and map scan precision can be determined and improved.

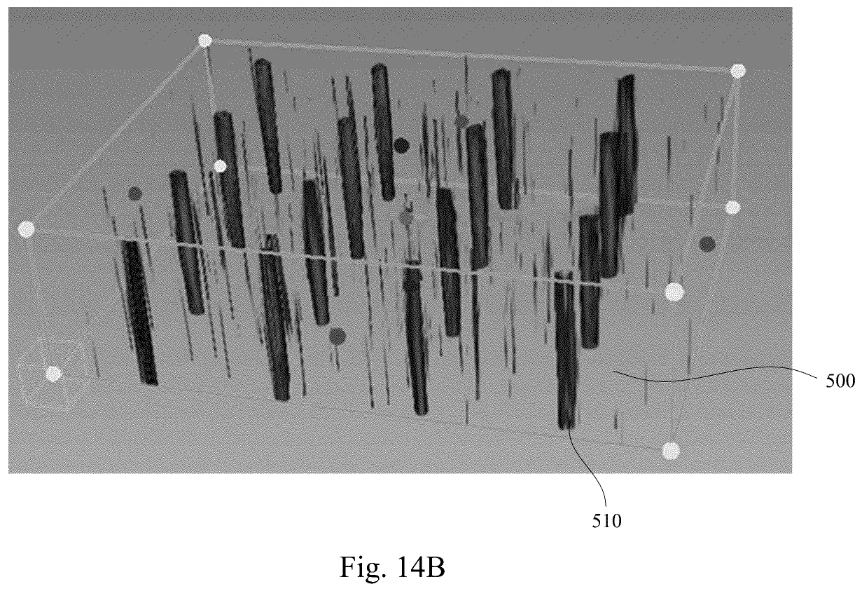

FIG. 14A to FIG. 14E are images of etched through holes 510 obtained by the digital microscope system 200 according to one embodiment of the present disclosure. Reference is made to FIG. 1C and FIG. 14A to FIG. 14E. Those images of the etched through holes 510 are processed to increase the resolution and are analyzed to obtain stereoscope image data of the etched through holes 510 by the calculating unit 300. For example, the stereoscope image data of the etched through holes 510 includes top critical dimension, middle critical dimension, bottom critical dimension, top roundness, bottom roundness, pitch, diameter, height, axial line, surface roughness, cross-sectional views, and map scan, but the present disclosure is not limited thereto. In addition, multiple through hole structures can be inspected at the same time such that the time required to scan the substrate is reduced. The taper angles of four corners of the through hole structures can be inspected such that the metal plating process can be applied to form through hole vias (i.e. metal conductors) that have much smaller critical dimensions.

FIG. 14A is an image of the surface of the substrate 500, which reveals the surface roughness of the substrate 500 affected during the etching procedure. The surface roughness is required to be in a suitable range such that the subsequent metal plating process can be well performed.

FIG. 14B is a 3D image of the substrate 500. FIG. 14C is a cross-sectional view of FIG. 14B along an axial direction. FIG. 14D is a cross-sectional view of FIG. 14B along a coronal direction. FIG. 14E is a cross-sectional view of FIG. 14B along a sagittal direction.

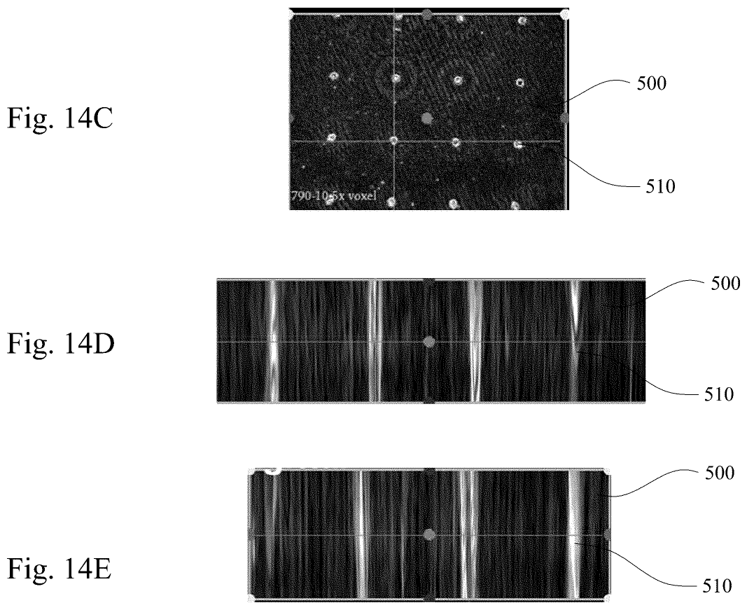

FIG. 15 is a schematic diagram of a reconstructed 3D point cloud data of the etched through holes 510. Multiple images in a 3D image stack corresponding to different height of an etched through hole can be processed and analyzed to obtain point cloud data PCD. As such, the point cloud data can be reconstructed to demonstrate the 3D profile of the etched though hole 510.

By inspecting the substrate 500 with the digital microscope system 200 and by processing and analyzing the 2D interference image, the 3D profile of the etched through holes 510 can be determined. In some embodiments, when the through hole structures 510 have elliptical shape which is not clear in an inclined projection image, it can be seen clearly in the stereoscopic image data or the 3D point cloud data.

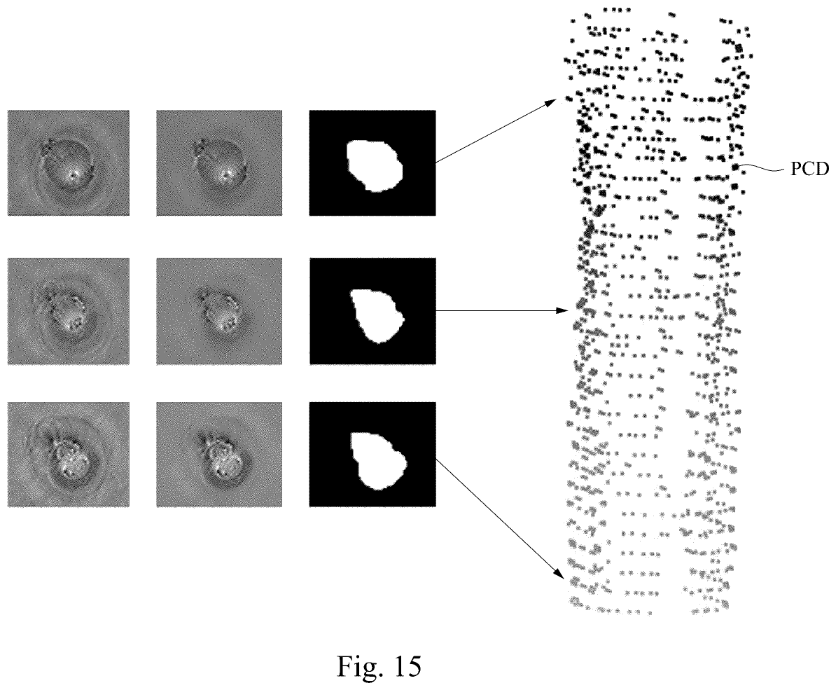

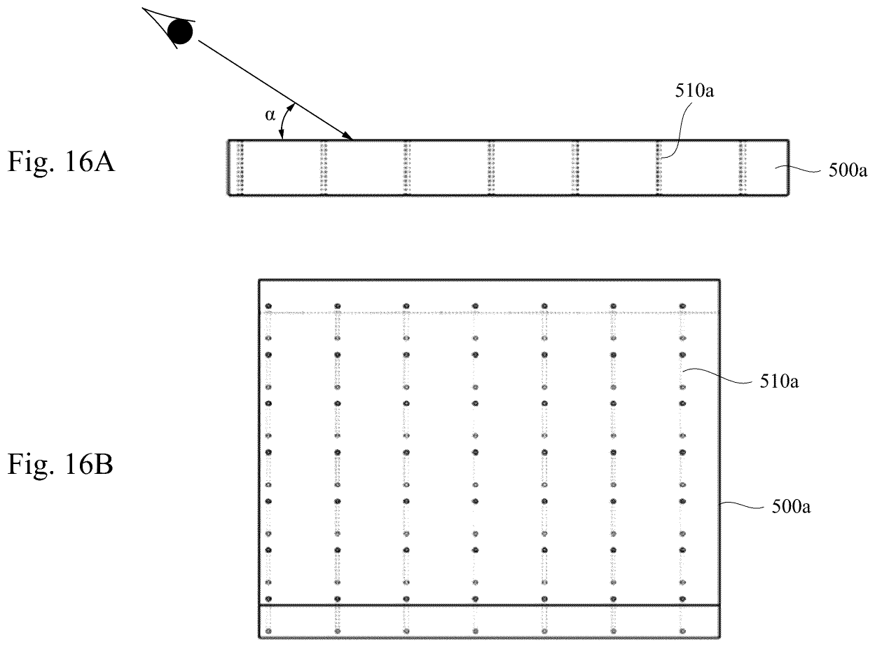

FIG. 16A is a schematic diagram of an inspection angle according to one embodiment of the present disclosure. The substrate 500a is inspected with an inspection angle α, such that the sidewall shape (see FIG. 7), diameter (see FIG. 7), profile (see FIG. 6 and FIG. 8), or defects can be inspected. FIG. 16B is a schematic diagram of an inspected image obtained with the inspection angle shown in FIG. 16A. In this embodiment, the through hole structures 510a are not overlapped with each other. In some embodiments, the inspection angle α is in a range from 15 degrees to 65 degrees. In some preferred embodiments, the inspection angle α is in a range from 40 degrees to 45 degrees, but the present disclosure is not limited thereto.

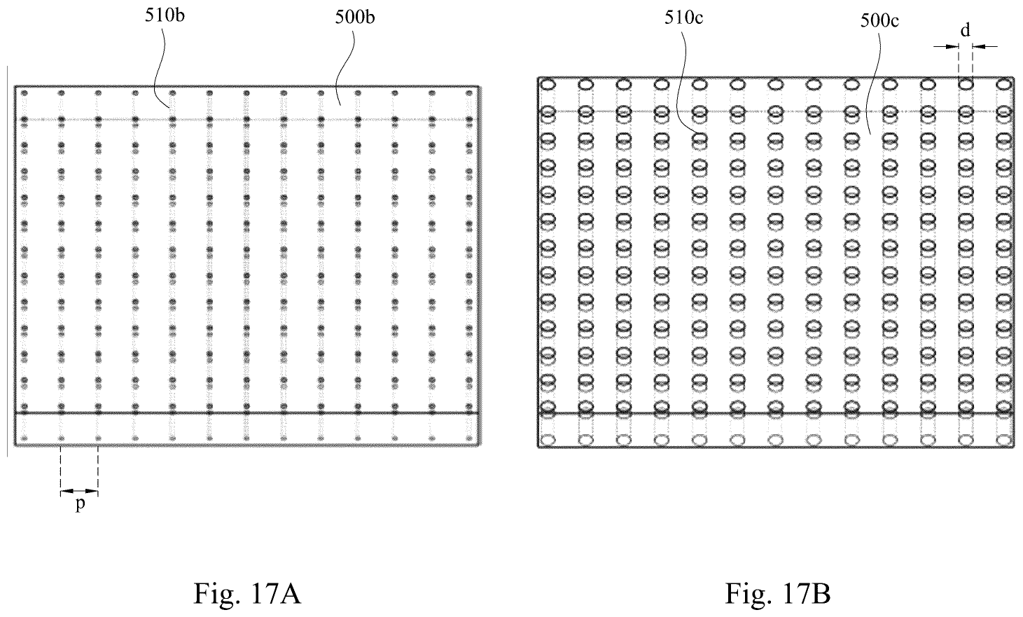

FIG. 17A and FIG. 17B are schematic diagram of inspected images with overlapped through hole structures. Comparing to FIG. 16B, the density of the through hole structures 510b in FIG. 17A is greater (i.e., the pitch p between the through hole structures 510b is smaller), and the diameter d of the through hole structures 510c in FIG. 17B is greater. As a result, overlapping between adjacent through hole structures 510b, 510c happened and the through hole structures cannot be inspected completely.

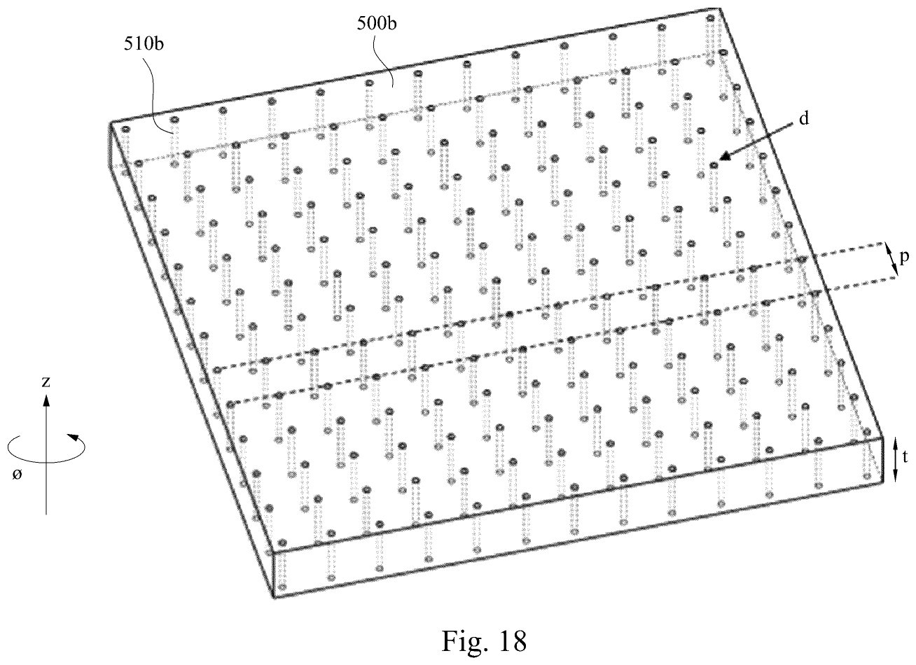

FIG. 18 is a schematic diagram of a rotation angle according to one embodiment of the present disclosure. The substrate 500b in FIG. 17A is inspected with the inspection angle α and a rotation angle ψ, such that the problems in FIG. 17A and FIG. 17B can be solved. In some embodiments, the rotation angle ψ is in a range from 0 degree to 50 degrees. In some preferred embodiments, the rotation angle ψ is in a range from 15 degrees to 45 degrees, but the present disclosure is not limited thereto.

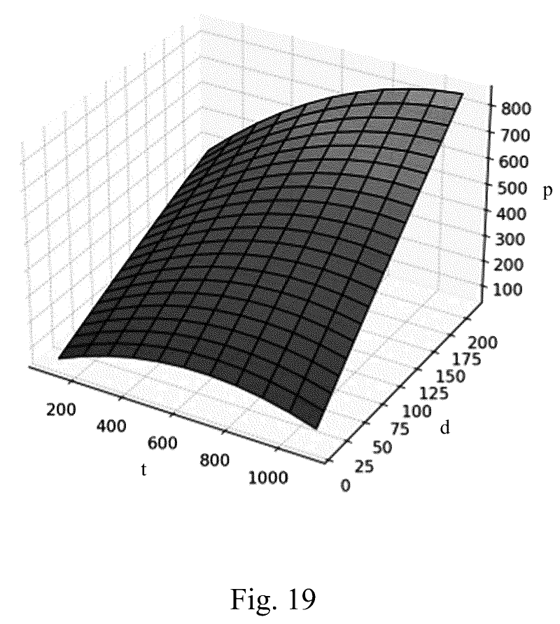

For example, when the inspection angle α is 45 degrees and the rotation angle ψ is 15 degrees, the relation between the minimum pitch p, the thickness t of the substrate, and the diameter d is described with a minimum pitch equation: p(t, d)=At²+Btd+Cd²+Dt+Ed+F. FIG. 19 is a minimum pitch diagram based on the minimum pitch equation.

As an example, the coefficient A is in a range from −0.000415484 to −0.000375915, the coefficient B is in a range from 0.00224595 to 0.00203205, the coefficient C is in a range from −0.00077763 to −0.00070357, the coefficient D is in a range from 0.526785 to 0.476615, the coefficient E is in a range from 1.677795 to 1.518005, and the coefficient F is in a range from −15.46797 to −13.99483. The coefficients A˜F are not limited by the ranged mentioned above.

According to the minimum pitch equation, the users of the optical inspection apparatus can calculate a proper pitch for the through hole structures in the substrate by the calculating unit to avoid overlapping. For example, when the thickness t is 1000 μm and the diameter d is 100 μm, the pitch can be about 434 to 480 um.

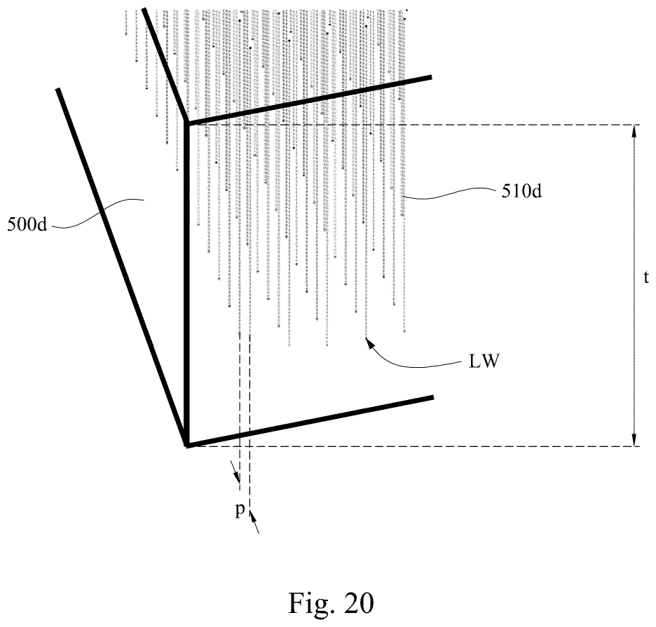

FIG. 20 is a schematic diagram of an inspected image of a laser modified substrate 500d according to one embodiment of the present disclosure. The minimum pitch equation can be applied before the substrate is laser modified. The diameter d in the minimum pitch equation represents the line width LW of the laser modified region 510d. Therefore, the users of the optical inspection apparatus can calculate a proper pitch for the laser modified regions 510d in the laser modified substrate 500d by the calculating unit to avoid overlapping.

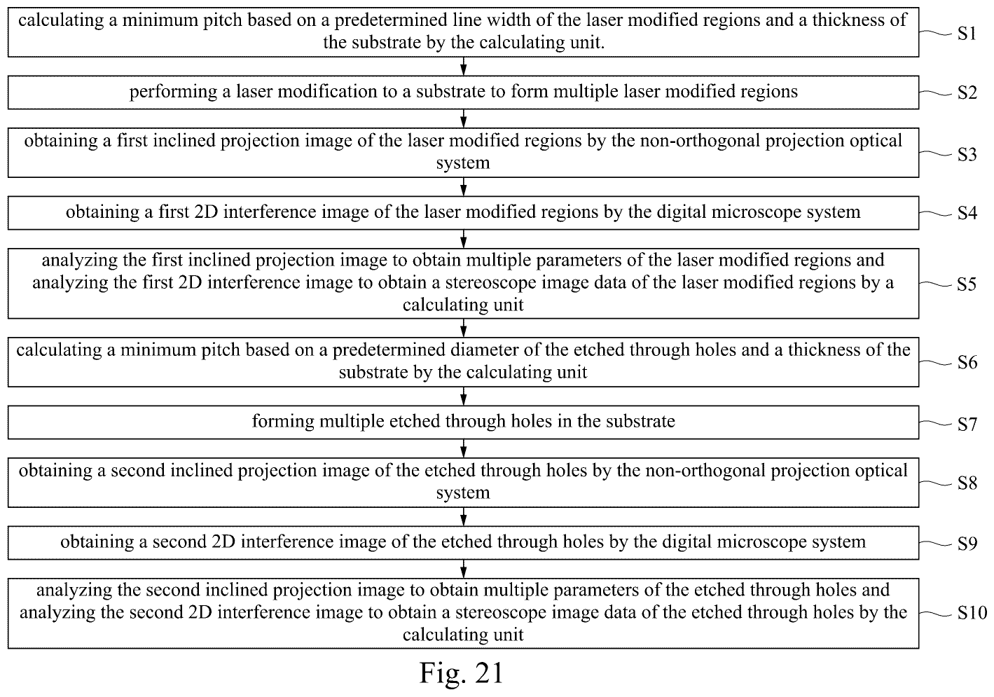

FIG. 21 is a flow chart of an operation method of an optical inspection apparatus 600. The operation method of the optical inspection apparatus 600 begins with step S1, in which a minimum pitch based on a predetermined line width of the laser modified regions and a thickness of the substrate is calculated by the calculating unit (see FIG. 1A). As shown in FIG. 20, the predetermined line width LW and the thickness t of the laser modified substrate 500d can determine a proper pitch p of the laser modified regions 510d before performing the laser modification. The operation method of the optical inspection apparatus 600 proceeds to step S2, in which a laser modification is performed to the substrate to form multiple laser modified regions.

Reference is made to FIG. 1A and FIG. 21. The operation method of the optical inspection apparatus 600 proceeds to step S3, in which an inclined projection image of the laser modified regions 510 is obtained by the projection optical system 100. The operation method of the optical inspection apparatus 600 proceeds to step S4, in which a 2D interference image of the laser modified regions is obtained by the digital microscope system 200. In some embodiments, the sequence of step S3 and step S4 can be exchanged.

The operation method of the optical inspection apparatus 600 proceeds to step S5, in which the inclined projection image is analyzed to obtain multiple parameters of the laser modified regions 510 and the 2D interference image is analyzed to obtain a stereoscope image data of the laser modified regions 510 by the calculating unit 300 (i.e., FIG. 3A to FIG. 3D and FIG. 13).

The operation method of the optical inspection apparatus 600 proceeds to step S6, in which a minimum pitch based on a predetermined diameter of the etched through holes and the thickness of the substrate is calculated by the calculating unit 300. As shown in FIG. 18, the predetermined diameter d and the thickness t of the substrate 500b can determine a proper pitch p of the etched through holes 510b before performing the etch process.

The operation method of the optical inspection apparatus 600 proceeds to step S7, in which multiple etched through holes 510 are formed in the substrate 500. The operation method of the optical inspection apparatus 600 proceeds to step S8, in which an inclined projection image of the etched through holes 510 is obtained by the projection optical system 100. The operation method of the optical inspection apparatus 600 proceeds to step S9, in which a 2D interference image of the etched through holes is obtained by the digital microscope system 200. In some embodiments, the sequence of step S8 and step S9 can be exchanged.

The operation method of the optical inspection apparatus 600 proceeds to step S10, in which the inclined projection image is analyzed to obtain multiple parameters of the etched through holes 510 and the 2D interference image is analyzed to obtain a stereoscope image data of the etched through holes 510 by the calculating unit 300 (i.e., FIG. 4 to FIG. 5, FIG. 11 to FIG. 12, FIG. 14A to FIG. 14E, and FIG. 15.).

In summary, the optical inspection apparatus is a contactless and nondestructive inspection method, such that a feedback can be provided in real-time. The shape and profile of the entire through hole structures can be obtained from the inclined projection image from a projection optical system and a 2D interference image from a digital microscope system. In addition, multiple through hole structures can be inspected at the same time such that the time required to scan the substrate is reduced. The taper angles of four corners of the through hole structures can be inspected such that the metal plating process can be applied to form through hole vias (i.e. metal conductors) that have much smaller critical dimensions. A proper pitch of the through hole structures can be calculated according to a minimum pitch equation to avoid overlapping before performing laser modification or etch process.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical inspection apparatus, comprising:
a projection optical system configured to obtain an inclined projection image of a plurality of through hole structures in a substrate;
a digital microscope system configured to obtain a 2D interference image; and
a calculating unit electrically connected to the projection optical system and the digital microscope system, wherein the calculating unit is configured to analyze the 2D interference image to obtain a stereoscope image data and to analyze the inclined projection image to obtain a plurality of parameters of the plurality of through hole structures.

2. The optical inspection apparatus of claim 1, wherein the projection optical system further comprises:
a light source configured to illuminate a back side of the substrate;
a projection lens located at a front side of the substrate, wherein the projection lens is configured to obtain the inclined projection image of the plurality of through hole structures; and
an image sensor configured to record an imaging from the projection lens.

3. The optical inspection apparatus of claim 2, wherein the projection lens of the projection optical system is a telecentric lens.

4. The optical inspection apparatus of claim 1, wherein the calculating unit is configured to perform extend depth of focus algorithm or all in focus algorithm to obtain the parameters of the plurality of through hole structures.

5. The optical inspection apparatus of claim 1, wherein the plurality of through hole structures are etched through holes, and the parameters comprise top critical dimension, middle critical dimension, bottom critical dimension, taper angle, pitch, diameter, roughness, height and central line.

6. The optical inspection apparatus of claim 1, wherein the plurality of through hole structures are laser modified regions, and the parameters comprise depth, angle, pitch, density, line width, and inner crack.

7. The optical inspection apparatus of claim 1, wherein the digital microscope system further comprises:
a laser light source configured to emit an incident light; and
an image sensor configured to record the 2D interference image formed by the incident light passed through the plurality of through hole structures.

8. The optical inspection apparatus of claim 7, further comprising:
a carrier, wherein the substrate is disposed on the carrier, and a distance between the carrier and the image sensor is adjustable.

9. The optical inspection apparatus of claim 1, wherein the calculating unit is configured to perform back-propagation reconstruction algorithm on the 2D interference image to obtain a 3D image stack of the plurality of through hole structures.

10. The optical inspection apparatus of claim 9, wherein the calculating unit is configured to perform twin image elimination algorithm to the 3D image stack.

11. The optical inspection apparatus of claim 9, wherein the calculating unit is configured to perform super-resolution algorithm to the 3D image stack.

12. The optical inspection apparatus of claim 1, wherein the plurality of through hole structures are etched through holes, and the stereoscope image data comprises top critical dimension, middle critical dimension, bottom critical dimension, taper angle, top roundness, bottom roundness, pitch, diameter, height, axial line, surface roughness, cross-sectional views, and map scan.

13. The optical inspection apparatus of claim 1, wherein the plurality of through hole structures are laser modified regions, and the stereoscope image data comprises laser modification precision and map scan.

14. An operation method of an optical inspection apparatus, comprising:
forming a plurality of etched through holes in a substrate;
obtaining a first inclined projection image of the plurality of etched through holes by a projection optical system;
obtaining a first 2D interference image of the plurality of etched through holes by a digital microscope system; and
analyzing the first inclined projection image to obtain a plurality of parameters and analyzing the first 2D interference image to obtain a stereoscope image data by a calculating unit.

15. The operation method of the optical inspection apparatus of claim 14, before forming the plurality of etched through holes in the substrate, calculating a minimum pitch based on a predetermined diameter of the etched through holes and a thickness of the substrate by the calculating unit.

16. The operation method of the optical inspection apparatus of claim 14, wherein obtaining the first inclined projection image of the plurality of etched through holes by the projection optical system further comprises:
illuminating a back side of the substrate by a light source;
obtaining the first inclined projection image of the plurality of etched through holes through a projection lens; and
recording an imaging of the projection lens by an image sensor.

17. The operation method of the optical inspection apparatus of claim 14, wherein obtaining the first 2D interference image of the plurality of etched through holes by the digital microscope system further comprises:
emitting an incident light towards the substrate by a laser light source; and
recording an imaging formed by the incident light passed through the plurality of etched through holes by an image sensor.

18. The operation method of the optical inspection apparatus of claim 14, further comprising:
before forming the plurality of etched through holes in the substrate, performing a laser modification to the substrate to form a plurality of laser modified regions.

19. The operation method of the optical inspection apparatus of claim 18, before performing the laser modification to the substrate to form the plurality of laser modified regions, calculating a minimum pitch based on a predetermined line width of the laser modified regions and a thickness of the substrate by the calculating unit.

20. The operation method of the optical inspection apparatus of claim 19, further comprising:
obtaining a second inclined projection image of the plurality of laser modified regions by the projection optical system; and
obtaining a second 2D interference image of the plurality of laser modified regions by the digital microscope system.
